(19) United States
(12) Patent Application Publication
(10) Pub. No.: US 2005/0048846 A1
(43) Pub. Date: Mar. 3, 2005

(54) Plug connector, receptacle connector, and joint-type connector

(76) Inventors: Mitsuo Suzuki, Tokyo (JP); Nobuyuki Kusuda, Tokyo (JP); Sadaaki Sakai, Kanagawa (JP)

Correspondence Address: ROBERT W. J. USHER;PATENT AGENT, 1133 BROADWAY, #1515, NEW YORK, NY, 10010, US

(21) Appl. No.: 10/916,197

(22) Filed: Aug. 11, 2004

(30) Foreign Application Priority Data
Aug. 26, 2003 (JP) 2003-301293

(51) Int. Cl. H01R 24/00

(52) U.S. Cl. 439/660

(57) ABSTRACT

A plug connector, comprising a housing 12 comprising a flat plug portion 14 extending in the left-right direction for insertion into a plug accommodation space 54a of a housing 52 of a receptacle connector 50 serving as a joining mate, and a signal contact 22 provided at the upper surface of the plug portion 14 and connected to a signal line (signal terminal on a board), the configuration of the plug connector being such that the signal contact 22 is brought into contact with a signal contact 62 of the mating connector in a state where the housing 12 has been joined to mating housing 52, wherein a power source contact 24 for connection to a power source line (power source terminal on a board) is provided at the lower surface of the plug portion 14.

### FIELD OF THE INVENTION

The present invention relates to a plug connector, a receptacle connector, and a joint-type connector used for connecting devices, such as personal computers or peripheral devices, with a signal cable conducting signal transmission between those devices.

### BACKGROUND OF THE INVENTION

Main boards of personal computers and internal hard disks, or main boards and peripheral devices (for example, external memory devices such as CD-ROM drives and DVD-ROM drives) are connected by signal cables conducting signal transmission between those devices, and the signal cable and the device are connected via a connector comprising a housing that can be joined to both of them. Replaceability of the connectors is ensured by standardization of the connector shape, and the corresponding contacts are brought into contact by joining the mating connector and the housing to each other. For example, a USB standard and a serial ATA standard (See Internet [search as of Aug. 11, 2003]: Teac System Create Homepage <URL: http://www.tsc.teac.co.jp/prod/s_ata/cs35sau.html>) are known as standards on connectors.

However, the connectors conforming to the aforementioned serial ATA standard were suitable only for signal transmission and when devices were connected via connectors of this type, power supply to the peripheral devices had to be conducted with a separately provided power source cable. As a result, a mounting space was necessary at the boards of the devices for a power supply line which resulted in increased size of the device and production cost.

### SUMMARY OF THE INVENTION

With the foregoing in view, it is an object of the present invention to provide a connector with a configuration making it possible to decrease the number of necessary connectors, to reduce the mounting space inside the device, to make the device compact, and to reduce the production cost.

The plug connector in accordance with the present invention is a plug connector, comprising a plug housing (for example, a housing 12 in the embodiment) comprising a flat plug portion extending in the left-right direction for insertion into a plug accommodation space of a receptacle housing (for example, a housing 52 in the embodiment) of a receptacle connector serving as a joining mate, and a plug-side signal contact (for example, a signal contact 22 in the embodiment) provided at the upper surface of the plug portion and connected to a signal line, the configuration of the plug connector being such that the plug-side signal contact is brought into contact with a receptacle-side signal contact (for example, a signal contact 62 in the embodiment) of the receptacle connector in a state where the plug housing has been joined to the receptacle housing, wherein a power source contact for connection to a power source line is provided at the lower surface of the plug portion. In such a plug connector, the outer periphery of the portion in the plug housing which is to be joined to the receptacle housing is preferably covered with a shielding member composed of an electrically conductive material. Furthermore, it is preferred that a shielding plate composed of an electrically conductive material be provided in the central portion in the up-down direction of the plug portion.

The receptacle connector in accordance with the present invention is a receptacle connector, comprising a receptacle housing (for example, a housing 52 in the embodiment) having a plug accommodation portion for accommodating a flat plug portion which extends in the left-right direction in a plug connector serving as a joining mate, and a receptacle-side signal contact (for example, a signal contact 62 in the embodiment) provided at the upper surface of the inner wall of a plug accommodation portion (for example, a plug accommodation portion 54 in the embodiment) forming the plug accommodation space and connected to a signal line, the configuration of the receptacle connector being such that the receptacle-side signal contact is brought into contact with a plug-side signal contact (for example, a signal contact 22 in the embodiment) of the plug connector in a state where the receptacle housing has been joined to the plug housing, wherein a power source contact for connection to a power source line is provided at the lower surface on the inner wall of the plug accommodation portion. In this receptacle connector, the outer periphery of the portion in the receptacle housing which is joined to the plug housing is covered with a shielding member composed of an electrically conductive material.

Further, a joint-type connector in accordance with the present invention is composed of mutually joinable plug connector in accordance with the present invention and the receptacle connector in accordance with the present invention. It is preferred that in this joint-type connector, the power source contact of the receptacle connector is formed to have a flat shape and is fixedly provided at the receptacle housing, and the power source contact of the plug connector is cantilever supported at the plug housing so that the contact can be elastically deformed in the up-down direction. Alternatively, the power source contact of the plug connector may be formed to have a flat shape and be fixedly provided at the plug portion of the plug housing, and the power source contact of the receptacle connector may be cantilever supported at the receptacle housing so that the contact can be elastically deformed in the up-down direction.

The plug connector in accordance with the present invention also comprises a power source contact for connection to a power source line, in addition to a signal contact (plug-side signal contact) for connection to a signal line. Therefore, if a power source contact is also provided in the mating receptacle connector, then not only signal transmission, but also power (electric power) supply can be carried out by coupling with this receptacle connector. Therefore the number of parts (connectors) that are required for connecting a device can be decreased by comparison with the case where a plug connector capable only of signal transmission is used and a special connector for power (electric power) supply is required. Furthermore, because the number of connectors is decreased, the mounting space inside a device (devices where the connector is attached, such as personal computers or peripheral devices which are to be connected thereof) can be reduced, the device can be made more compact and the production cost can be reduced.

Furthermore, the plug connector in accordance with the present invention comprises a contact (power source contact) for power (electric power) supply to a plug connector (for example, a plug connector conforming to a serial ATA standard) that has been conventionally employed and this power source contact is provided at the lower surface of the plug portion where the contacts have not been conventionally disposed. Therefore, the housing can be joined to the housing of conventional receptacle connectors (thereby providing for replaceability with the plug connectors that are joined with the conventional receptacle connectors). Therefore, coupling is also possible to the conventional receptacle connectors that are not provided with power source contacts and the connector can be used only for signal transmission, without power supply. Furthermore, in the plug connector in accordance with the present invention, the outer periphery of the portion of the housing which is to be joined to the mating housing is covered with a shielding member composed of an electrically conductive material. As a result, electric characteristics can be improved. Furthermore, if a shielding plate composed of an electrically conductive material is provided in the central portion in the up-down direction of the plug portion, the occurrence of crosstalk between the signal contact (plug-side signal contact) and the power source contact of the plug connector can be prevented.

Furthermore, the receptacle connector in accordance with the present invention, comprises a power source contact for connection to a power source line in addition to a signal contact (receptacle-side signal contact) for connection to a signal line. Therefore, if a power source contact is also provided in the mating plug connector, then, not only signal transmission, but also power (electric power) supply can be conducted by coupling with the plug connector. For this reason, the number of parts (connectors) that are required for connecting a device can be decreased by comparison with the case where a receptacle connector capable only of signal transmission is used and a special connector for power (electric power) supply is required. Furthermore, because the number of connectors is decreased, the mounting space inside a device can be reduced, the device can be made more compact and the production cost can be reduced.

Furthermore, the receptacle connector in accordance with the present invention comprises a contact (power source contact) for power (electric power) supply to a receptacle connector (for example, a receptacle connector conforming to a serial ATA standard) that has been conventionally employed and this power source contact is provided at the lower surface of the inner wall of the plug accommodation portion that has not been provided in the conventional contacts. Therefore, the housing can be joined to the housing of the conventional plug connectors (thereby providing for replaceability with the receptacle connectors that are joined with the conventional plug connectors). Therefore, coupling is also possible to the conventional plug connectors that are not provided with power source contacts and the connector can be used only for signal transmission, without power supply. Furthermore, in the receptacle connector in accordance with the present invention, the outer periphery of the portion of the housing which is to be joined to the mating housing is covered with a shielding member composed of an electrically conductive material. As a result, electric characteristics can be improved.

Further, in the joint-type connector in accordance with the present invention, not only signal transmission, but also power (electric power) supply can be carried out between the plug connector and receptacle connector which are joined. Moreover, if one of the power source contact of the receptacle connector and the power source contact of the plug connector is formed to have a flat shape and fixed to the housing and the other is cantilever supported so that it can be elastically deformed with respect thereto, then an accurate and appropriate contact force can be ensured for the power source contact.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only and thus are not limitative of the present invention.

FIG. 1 is a cross-sectional view illustrating a state in which a plug connector and a receptacle connector constituting a joint-type connector in accordance with the present invention are coupled;

FIG. 2A is a perspective view of the plug connector in accordance with the present invention, FIG. 2B is a perspective view of the receptacle connector in accordance with the present invention;

FIG. 3A is a plan view of the plug connector, FIG. 3B is a front view thereof, and FIG. 3C is a cross-sectional view as viewed from the IIIC-IIIC arrow in FIG. 3A;

FIG. 4A is a pan view of the receptacle connector, FIG. 4B is a front view thereof, FIG. 4C is a cross-sectional view as viewed from the IVC-IVC arrow in FIG. 4A, and FIG. 4D is a cross-sectional view as viewed from the IVD-IVD arrow in FIG. 4C;

FIG. 5 is a cross-sectional view of the electric cable for connection to the receptacle connector;

FIG. 6 is a cross-sectional view (partial) illustrating the coupling state of the plug connector and receptacle connector;

FIG. 7 is a cross-sectional view of the plug connector of the first modification example;

FIG. 8 illustrates the plug connector of the second modification example, FIG. 8A is a plan view, FIG. 8B is a front view, FIG. 8C is a left side view, and FIG. 8D is a cross-sectional view as viewed from the VIIID-VIIID arrow in FIG. 8A;

FIG. 9 illustrates a modification example of the receptacle connector of the first modification example, FIG. 9A is a plan view, FIG. 9B is a front view, and FIG. 9C is a cross-sectional view as viewed from the IXC-IXC arrow in FIG. 9A; and

FIG. 10 is a cross-sectional view illustrating the coupling state of the plug connector of the second modification example and receptacle connector of the first modification example.

### DESCRIPTION OF THE PREFERRED EMBODIMENTS

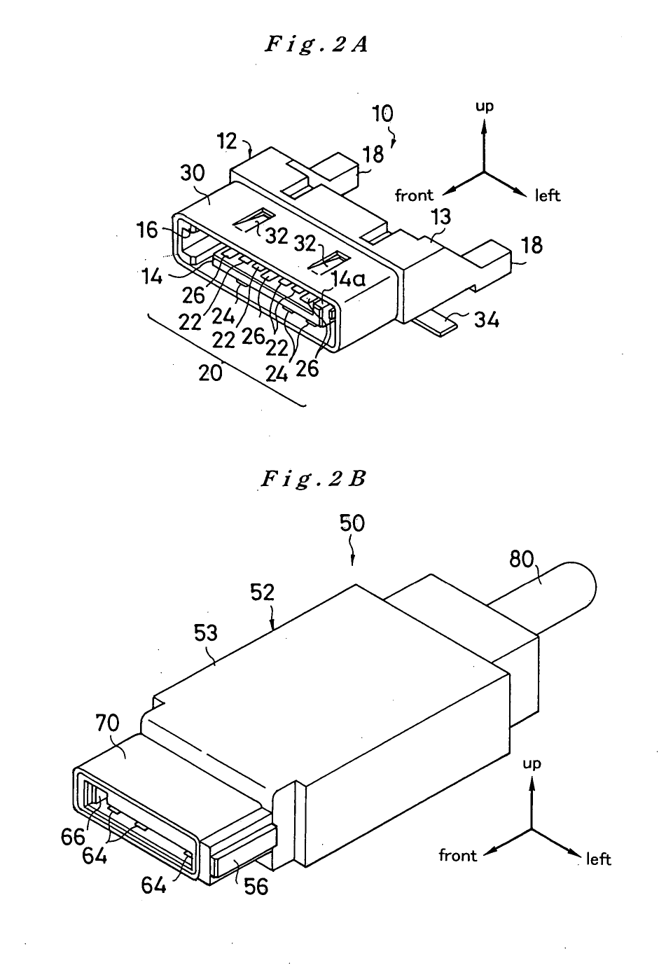

The preferred embodiments of the present invention will be described hereinbelow with reference to the appended drawings. FIG. 2 is a joint-type connector of the present invention. FIG. 2A shows a plug connector 10 (corresponds to the plug connector in accordance with the present invention) constituting the joint-type connector, and FIG. 2B shows a receptacle connector 50 (corresponds to the receptacle connector in accordance with the present invention) used for joining to the plug connector 10. In the present embodiment, for convenience of explanation, the front-rear, left-right, and up-down directions for the plug connector 10 and receptacle connector 50 are defined as shown in the figure.

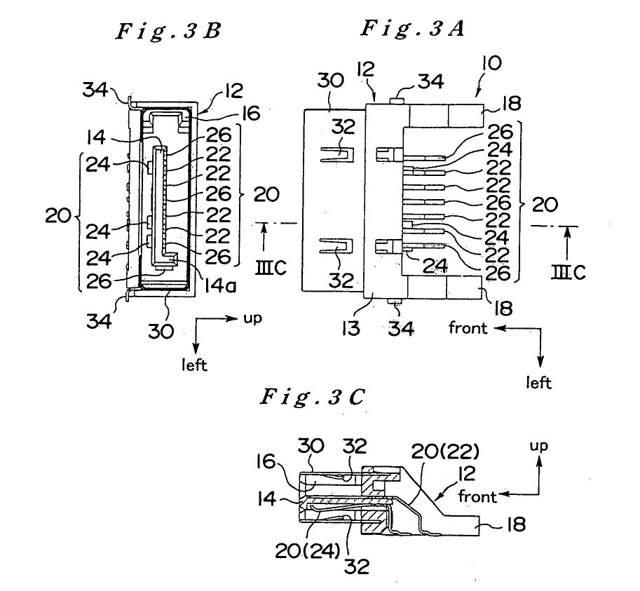

First, the plug connector 10 will be described by combining FIG. 3 with FIG. 2A. The plug connector 10 is based on a well-known plug connector conforming to a serial ATA standard (more specifically, it is a plug connector conforming to a serial ATA standard equipped with the below-described power source contact 24). The plug connector 10 comprises a housing 12 composed of an electrically insulating material, a plurality of contacts 20 made from an electrically conductive material and fixed to the housing 12, and a shielding member 30 composed of an electrically conductive material and provided in the front portion of the housing 12. The housing 12 has a shape with a thin body 13 thereof extending in the left-right direction. It comprises a flat plug portion 14 protruding forward from the central portion at the front side of the body 13 and extending in the left-right direction, a guiding portion 16 with a U-shaped cross section provided so as to protrude and extend forward from the right end portion at the front side of the body 13, and left and right leg portions 18, 18 extending rearward from the left and right end portions at the rear side of the body 13. A protrusion 14a which protrudes upward is formed at the left end of the plug portion 14, and he plug portion 14 as a whole has a L-shaped cross section.

The contacts 20 are composed of four signal contacts 22, three power source contacts 24, and four ground contacts 26. The four signal contacts 22 are provided so that they extend parallel each other in the front-rear direction on the upper surface of the plug portion 14, and the three power source contacts 24 are provided so that they extend parallel each other in the same direction (front-rear direction) as the signal contacts 22 on the lower surface of the plug portion 14. Furthermore, three of the four ground contacts 26 are provided so that they extend parallel each other in the same direction as the signal contacts 22 (front-rear direction) on the upper surface of the plug portion 14, and the remaining one ground contact is provided so that it extends in the front-rear direction on the left side surface of the plug portion 14. Here, the four signal contacts 22 are formed as flat plates and are fixed to the upper surface of the plug portion 14. The three ground contacts 26 provided at the upper surface of the plug portion are similarly formed as flat plates and are fixed to the upper surface of the plug portion. Furthermore, the three power source contacts 24 are cantilever supported at the body 13 of the housing 10 so that they can deform elastically in the up-down direction, and one ground contact 26 which is provided at the left side surface of the plug portion 14 is also cantilever supported therein so that it can deform elastically in the left-right direction. Further, the contacts 20 will be connected to prescribed terminals (the signal contacts 22 are connected to signal terminals, power source contacts 24 are connected to power source terminals, and ground contacts 26 are connected to ground terminals) provided on a board (not shown in the figure) where the plug connector 10 is to be mounted.

The shielding member 30 has a hollow rectangular cross-sectional shape and is fixed to the housing 12 so that it covers the outer periphery of the plug portion 14. Here, contact portions 32 (a total of four) bent inwardly (downward at the upper surface side and upward at the lower surface side) are formed at the left and right portions of the upper surface and lower surface. Furthermore, lead portions 34, 34 for grounding which are bent and extend outwardly in the left-right direction are formed at the left and right side portions of the shielding member 30. Those lead portion 34, 34 for grounding are connected to the ground terminals of the aforementioned board where the plug connector 10 is to be mounted. The housing 12 of the plug connector 10 is formed by resin molding, but the shielding member 30 and the aforementioned contacts 20 are integrally mounted on the housing 12 simultaneously with the formation of the housing 12 by inserting them into the mold in advance of the molding of the housing 12 (the so-called insert molding. This is merely an example, and the insert molding is not necessarily used. Same is true for the below-described receptacle connector 50).

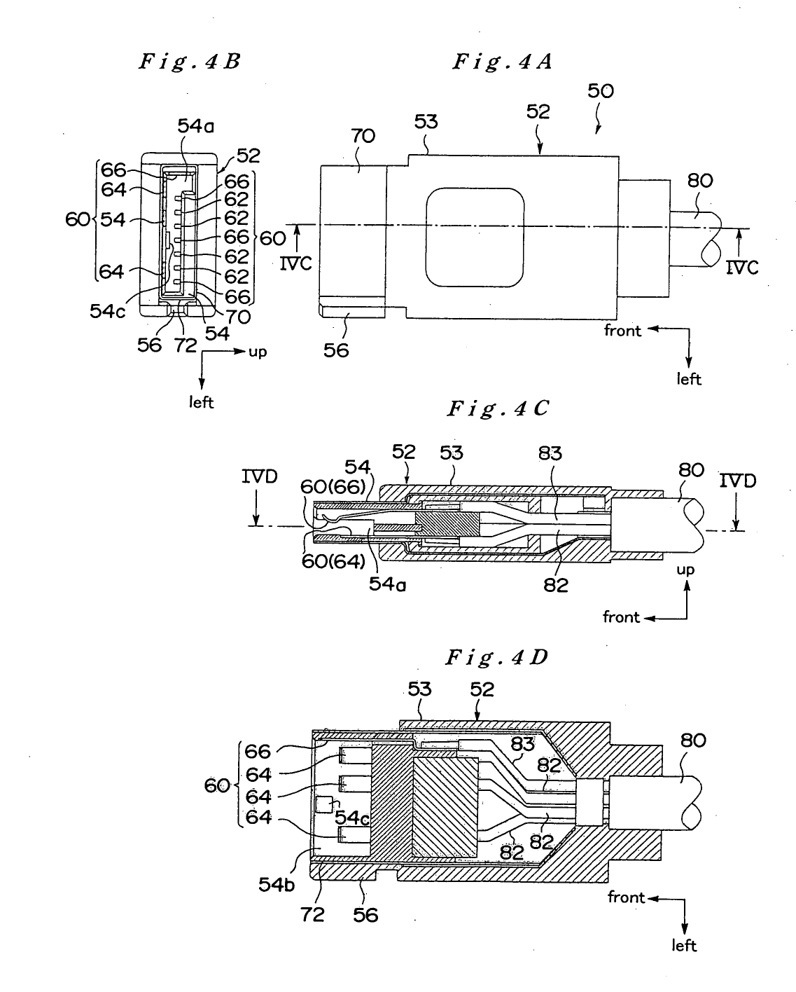

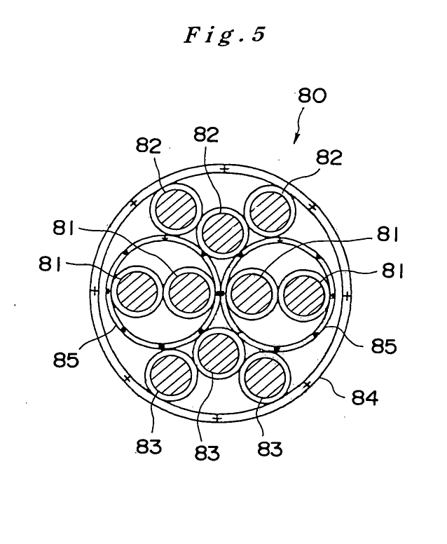

The receptacle connector 50 will be described hereinbelow by combining FIG. 4 and FIG. 5 with FIG. 2B. The receptacle connector 50 is based on a well known receptacle connector conforming to a serial ATA standard (more specifically, a receptacle connector conforming to a serial ATA standard which is equipped with the below-described power source contact 64). The receptacle connector 50 comprises a housing 52 composed of an electrically insulating material, a plurality of contacts 60 composed of an electrically conductive material and fixed to the housing 52, and a shielding member 70 composed of an electrically conductive material and provided in the front portion of the housing 52. The housing 52 has a shape such that the body 53 thereof is somewhat elongated and extends in the front-rear direction, and a plug accommodation member 54 is provided in the central portion at the front side of the body 53, this plug accommodation member having formed inside thereof a plug accommodation space 54a with an L-shaped cross section, which can accommodate the plug portion 14 of the aforementioned plug connector 10 which is inserted from the front side. Furthermore, there is also provided an extending portion 56 which extends forward from the left end side (the side to the left of the plug accommodation member 54) of the housing 52.

The contacts 60 are composed of four signal contacts 62, three power source contacts 64, and four ground contacts 66, corresponding to the contacts 20 of the above-described plug connector 10. The four signal contacts 62 are provided so as to extend parallel to the front-rear direction at the front surface of the inner wall of the plug accommodation member 54. The three power source contacts 64 are provided so as to extend in the same direction (front-rear direction) as the signal contacts 62 at the lower surface on the inner wall of the plug accommodation member 54. Further, three of the four ground contacts 66 are provided so as to extend parallel to the same direction (front-rear direction) as the signal contacts on the upper surface of the inner wall of the plug accommodation member 54, and the remaining one ground contact is provided so as to extend in the front-rear direction on the right surface of the inner wall of the plug accommodation member 54. Here, all the three power source contacts 64 are formed to have a flat shape and are fixed to the lower surface of the inner wall of the plug accommodation member 54. One ground contact 66 provided at the right surface of the inner wall of the plug accommodation member 54 is also formed to have a flat shape and is fixed to the right surface of the inner wall of the plug accommodation member 54. Further, the four signal contacts 62 and three ground contacts 66 provided at the upper surface of the inner wall of the plug accommodation member 54 are cantilever supported on the body 53 of the housing 50 so that they can be deformed elastically in the up-down direction.

The shielding member 70 has a cross section in the form of a hollow rectangle and is fixed to the housing 52 so as to cover the outer periphery of the plug accommodation member 54. Here, a left wall portion 72 thereof is positioned between the plug accommodation member 54 and the extending portion 56 of the housing 52. A cable harness 80 for connection to the receptacle connector 50, as shown in FIG. 5, has a configuration in which all of a plurality of signal cables 81, power source cables 82, and ground cables 83 are covered with an outer shield 84. The signal cables 81 are connected to signal contacts 62, the power source cables 82 are connected to the power source contacts 64, and the ground cables 83 are connected to the ground contacts 66. The housing 52 of the receptacle connector 50 is formed by resin molding. The shielding member 70, the aforementioned contacts 62, 64, 66, and cables 81, 82, 83 for connection to those contacts 62, 64, 66 are integrally attached to the housing 52 simultaneously with the formation of the housing 52 by inserting them in advance into a mold during molding of the housing 52.

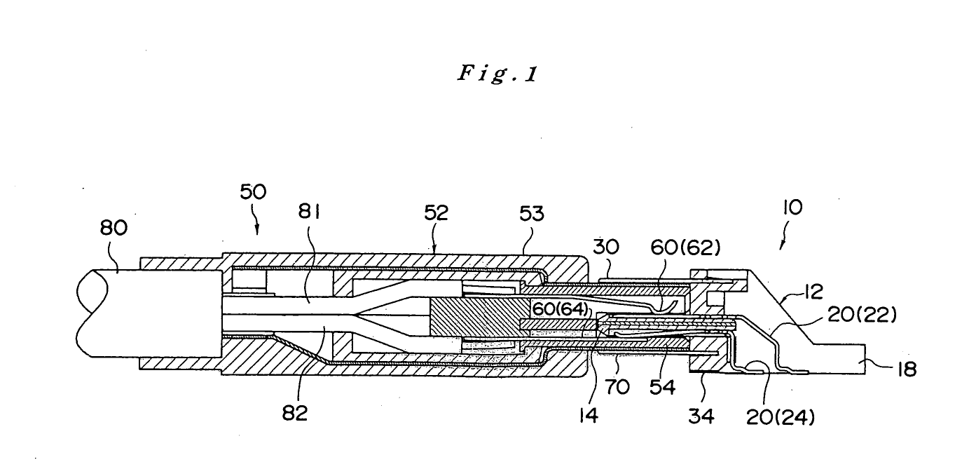

FIG. 1 is a cross-sectional view illustrating a state in which the plug connector 10 is coupled to the receptacle connector 50. Coupling of the plug connector 10 and receptacle connector 50 is carried out by joining the plug portion 14 of the plug connector 10 to the plug accommodation member 54 of the receptacle connector 50. In this process, the plug portion 14 (including the protruding portion 14a) with an L-shaped cross section of the plug connector 10 is inserted into the plug accommodation space 54a with an L-shaped cross section of the receptacle connector 50, and the extending portion 56 provided at the receptacle connector 50 enters a guiding portion 16 with a U-like cross section which is provided in the plug connector 10.

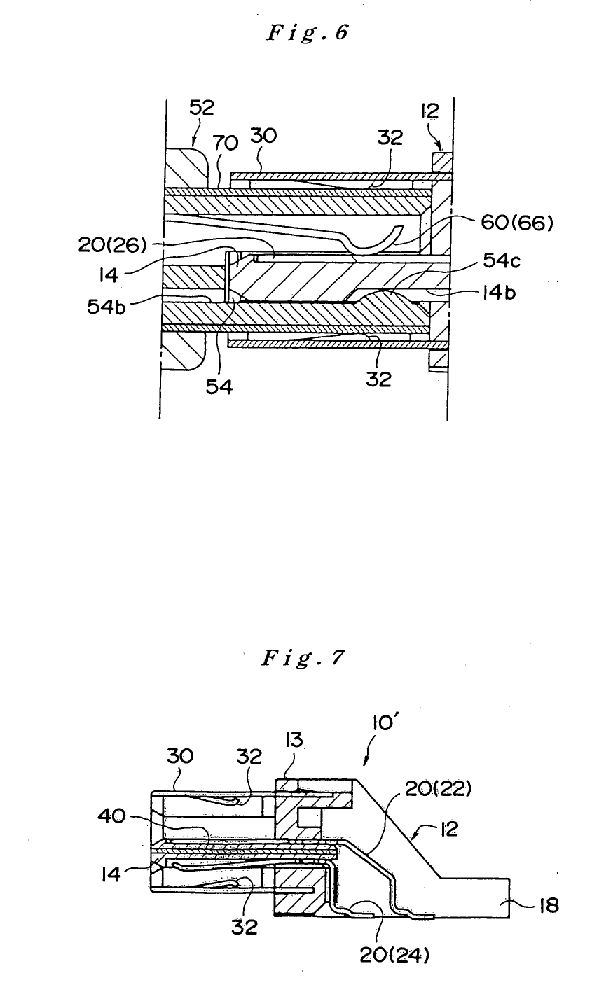

If the plug portion 14 of the plug connector 10 is inserted into the plug accommodation space 54a of the receptacle connector 50, the protruding portion 54c (see FIGS. 4B, D) which is formed so as to protrude and extend upward from the front end portion of the lower wall 54b forming the plug accommodation member 54 of the receptacle connector 50 enters a recessed portion 14b formed in the lower surface of the plug portion 14 of the plug connector 10 (see FIG. 6). As a result, the plug connector 10 and receptacle connector 50 are held in a coupled state (they are locked together). In this state the signal contact 22 of the plug connector 10 is in contact with the signal contact 62 of the receptacle connector 50, and the ground contact 26 of the plug connector 10 is in contact with the ground contact 66 of the receptacle connector 50. At this time, the signal contact 62 and ground contact 66 of the receptacle connector 50 are pushed upward and bent by respective signal contact 22 and ground contact of the plug connector 10, thereby ensuring a reliable and appropriate contact force.

Further, as described hereinabove, when the plug connector 10 and receptacle connector 50 are coupled, the power source contact 24 of the plug connector 10 is in contact with the power source contact 64 of the receptacle connector 50. At this time, the power source contact 64 of the receptacle connector 50 is pushed downward and bent by the power source contact 24 of the plug connector 10, thereby ensuring a reliable and appropriate contact force. Further, in the aforementioned coupled state, the shielding member 30 of the plug connector 10 is in contact with the shielding member 70 of the receptacle connector 50. At this time, the aforementioned contact portion 32 formed in the shielding member 30 of the plug connector 10 is pushed upward or downward and bent by the shielding member 70 of the receptacle connector 50, and a reliable and appropriate contact force is ensured between the two shielding members 30, 70.

As described hereinabove, in a state where the plug connector 10 and receptacle connector 50 are coupled together, the signal contact 22 of the plug connector 10 is in contact with the signal contact 62 of the receptacle connector 50. Therefore, signals can be transmitted between the two connectors 10, 50. Further, because the power source contact 24 of the plug connector 10 is in contact with the power source contact 64 of the receptacle connector 50, electric power can be supplied between the two connectors 10, 50. Moreover, because the ground contact 26 of the plug connector 10 is in contact with the ground contact 66 of the receptacle connector 50, the ground contacts 26, 66 of the two connectors 10, 50 can be grounded via the above described board where the plug connector 10 is mounted. Further, because the shielding member 30 of the plug connector 10 is in contact with the shielding member 70 of the receptacle connector 50, the shielding members 30, 70 of the two connectors 10, 50 are also grounded via the board at the side of the plug connector 10.

Thus, in the joint-type connector (plug connector 10 and receptacle connector 50) in accordance with the present invention, in addition to the signal contacts 22, 62 for connection to signal lines (a signal terminal on a board in the plug connector 10 and a signal cable 81 in the receptacle connector 50), there are also provided the power source contacts 24, 64 for connection to the power source line (a power source terminal on a board in the plug connector 10, and the power source cable 82 in the receptacle connector 50). Therefore, coupling to a mating connector (the receptacle connector 50 with respect to the plug connector 10, and the plug connector 10 with respect to the receptacle connector 50) makes it possible to conduct not only the transmission of signals but also the supply of power (electric power). Therefore the number of parts (connectors) that are required for connecting a device can be decreased by comparison with the case where a connector capable only of signal transmission is used and a special connector for power (electric power) supply is required. Furthermore, because the number of connectors is decreased, the mounting space inside a device (devices where the connector is attached, such as personal computers or peripheral devices which are to be connected thereto) can be reduced, the device can be made more compact and the production cost can be reduced.

Furthermore, the plug connector 10 in accordance with the present invention comprises a contact (power source contact 24) for power (electric power) supply to a plug connector (for example, a plug connector conforming to a serial ATA standard) that has been conventionally employed and this power source contact 24 is provided at the lower surface of the plug portion 14 where contacts have not been conventionally disposed. Therefore, the housing 12 can be joined (thereby providing for replaceability with the plug connectors that are joined with the receptacle connectors conforming to a serial ATA standard) to the housing of conventional receptacle connectors (receptacle connectors conforming to a serial ATA standard). Therefore, coupling is also possible to the conventional receptacle connectors (receptacle connectors conforming to a serial ATA standard) that are not provided with power source contacts and the connector can be used only for signal transmission, without power supply. Furthermore, in the plug connector 10 in accordance with the present invention, the outer periphery of the portion (plug portion 14) of the housing 12 which is to be joined to the mating housing is covered with a shielding member 30 composed of an electrically conductive material. As a result, good electric characteristics can be obtained.

Furthermore, the receptacle connector 50 in accordance with the present invention comprises a contact (power source contact 64) for power (electric power) supply to a receptacle connector (for example, a receptacle connector conforming to a serial ATA standard) that has been conventionally employed and this power source contact 64 is provided at the lower surface of the inner wall of the plug accommodation member 54 that has not been provided in the conventional contacts. Therefore, the housing 52 can be joined (thereby providing for replaceability with the receptacle connectors that are joined to the plug connectors conforming to a serial ATA standard) to the housing of conventional plug connectors (plug connectors conforming to a serial ATA standard). Therefore, coupling is also possible to the conventional plug connectors (plug connectors conforming to a serial ATA standard) that are not provided with power source contacts and the connector can be also used only for signal transmission, without power supply. Furthermore, in the receptacle connector 50 in accordance with the present invention, the outer periphery of the portion (plug accommodation member 54) of the housing 52 which is to be joined to the mating housing is covered with a shielding member 70 composed of an electrically conductive material. As a result, good electric characteristics can be obtained.

Further, in the plug connector 10, the signal contact 22 and power source contact 24 are positioned separately on the upper surface side and lower surface side of the plug portion 14, respectively. Therefore, providing a shielding plate 40 composed of an electrically conductive material in the central portion in the up-down direction of the plug portion 14, as in the plug connector 10′ of the first modification example shown in FIG. 7 (in FIG. 7, the structural components identical to those of the above-described plug connector 10 are assigned with identical symbols) makes it possible to prevent the occurrence of crosstalk between the signal contact 22 and power source contact 24. However, the shielding plate 40 has to be connected to the ground terminal of the board where the plug connector 10 is mounted.

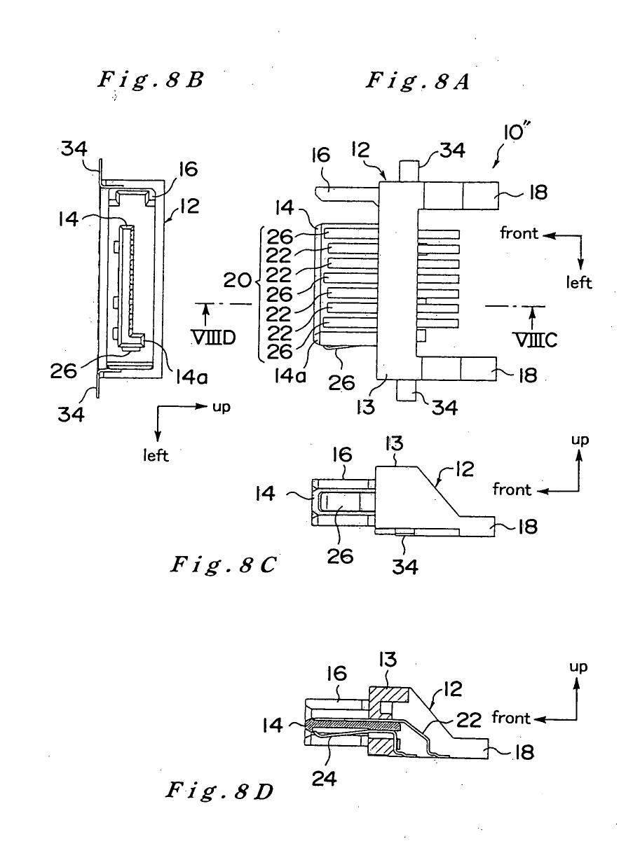

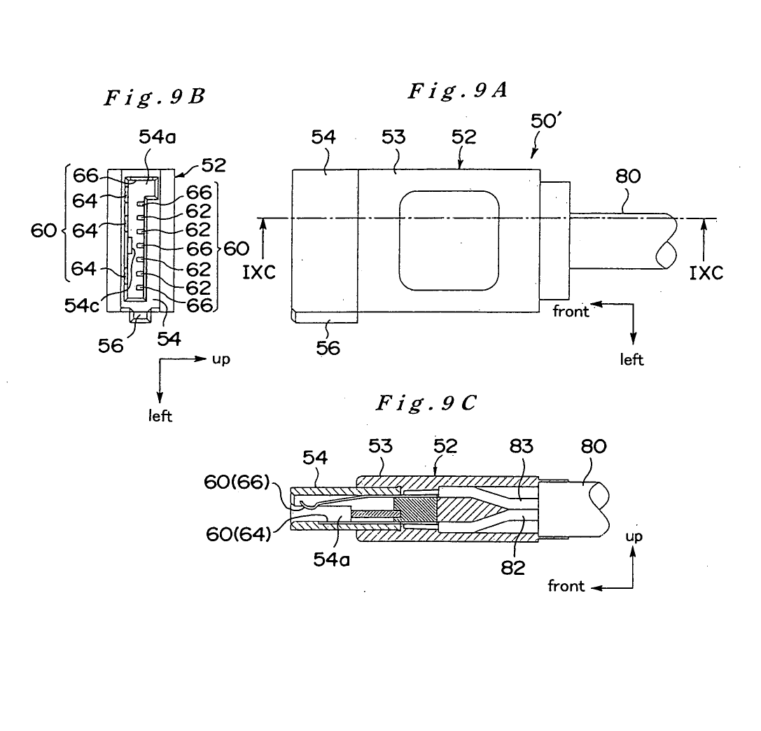

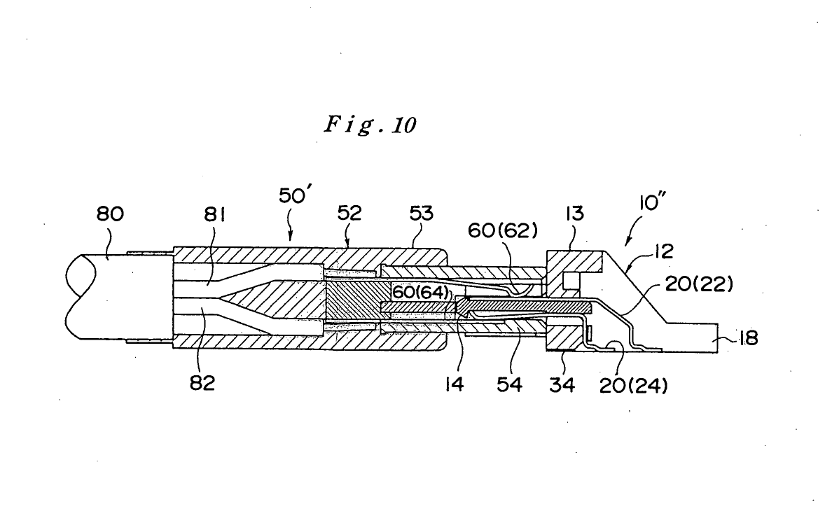

FIG. 8 shows a plug connector 10″ of the second modification example, the configuration thereof being obtained by removing the shielding member 30 from the plug connector 10 (in FIG. 8, the structural components identical to those of the above-described plug connector 10 are assigned with identical symbols). Further, FIG. 9 shows a receptacle connector 50′ of the first modification example, the configuration thereof being obtained by removing the shielding member 70 from the receptacle connector 50 (in FIG. 9, the structural components identical to those of the above-described plug connector 10 are assigned with identical symbols). With such a configuration, the electric characteristics are somewhat degraded by comparison with those obtained when the shielding member 30 was present, but the effect obtained is that power supply can be conducted in addition to signal transmission. FIG. 10 is a cross-sectional view illustrating the coupling state of the plug connector 10″ shown in FIG. 8 and the receptacle connector 50′ shown in FIG. 9.

The preferred embodiment of the present invention was described hereinabove, but the scope of the present invention is not limited to the above-described preferred embodiment. For example, in the above-described preferred embodiment, the explanation was conduced with respect to the case in which the connector (plug connector 10 and receptacle connector 50) of the present invention was based on the connector conforming to the serial ATA standard, but the connector in accordance with the present invention may be also based on the connector conforming to a conventional standard which conducts only signal transmission and is not necessarily based on the connector conforming to the serial ATA standard.

Furthermore, in the above-described preferred embodiment of the joint-type connector in accordance with the present invention, a configuration was employed in which the power source contact 64 of the receptacle connector 50 was formed to have a flat shape and was fixed to the housing 52, and the power source contact 24 of the plug connector 10 was cantilever supported on the housing 12 so that the contact could be elastically deformed in the up-down direction, but the reversed configuration can be also used. Thus, a configuration may be employed in which the power source contact 24 of the plug connector 10 is formed to have a flat shape and is fixed to the housing 12, and the power source contact 64 of the receptacle connector 50 is cantilever supported on the housing 52 so that the contact could be elastically deformed in the up-down direction. In both cases, a reliable and appropriate contact force can be ensured for the power source contacts 24, 64.

Furthermore, it is also possible that during coupling of the two connectors 10, 50, the contact of the signal contact 22 of the plug connector with the signal contact 62 of the receptacle connector 50, the contact of the power source contact 24 of the plug connector 10 with the power source contact 64 of the receptacle connector 50, and the contact of the ground contact 26 of the plug connector 10 with the ground contact 66 of the receptacle connector 50 are not carried out at the same time, and the respective connections are conducted (with delay in time) in a prescribed order (the so-called time-difference connection); such a configuration was not described in the aforementioned preferred embodiment. For example, there is a risk of sparks occurring if the signal contacts 22, 62 are brought into contact after the electric power has been supplied between the connectors 10, 50, but the ground contacts 22, 66 may be first brought into contact in order to avoid the sparks. Thus, the contact can be carried out in the following order: (1) ground contacts 26, 66→power source contacts 24, 64→signal contacts 22, 62, or (2) ground contacts 26, 66→power source contacts 24, 64 and signal contacts 22, 62 at the same time.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

### RELATED APPLICATIONS

This application claims the priority of Japanese Patent Application No.2003-301293 filed on Aug. 26, 2003, which is incorporated herein by reference.

1. A plug connector, comprising:
a plug housing comprising a flat plug portion having an upper surface and a lower surface which extend in a left-right direction for insertion into a plug accommodation space of a receptacle housing of a mating receptacle connector; and
a plug-side signal contact provided at the upper surface of said plug portion and connected to a signal line,
a receptacle-side signal contact on said receptacle connector, the plug connector being configured such that
said plug-side signal contact is brought into contact with a receptacle-side signal contact of said receptacle connector when said plug portion has been inserted into said plug accommodation space and said plug housing has been mated with said receptacle housing, wherein
a plug-side power source contact for connection to a power source line is provided at the lower surface of said plug portion.

2. The plug connector according to claim 1, wherein a portion of said plug housing which is to be mated with said receptacle housing has a periphery which surrounds said plug portion and is covered with a shielding member composed of an electrically conductive material.

3. The plug connector according to claim 1, wherein said plug portion has a central portion and a shielding plate composed of an electrically conductive material is provided to extend horizontally in the central portion of said plug portion.

4. The plug connector according to claim 1, wherein said plug portion has a left side wall and a right side wall and an L-shape cross section and extends in a front-back direction, the L-shape resulting in one of the side walls having a larger vertical height corresponding to a base of the L-shape; and, a grounded plug-side ground contact is provided at the side wall with a larger vertical height.

5. The plug connector according to claim 1, wherein one of said plug-side signal contact and said plug-side power source contact is mounted immovably at one of the upper surface and lower surface of said plug portion and another of said plug-side signal contact and said plug-side power source contact is mounted for elastic deformation in a vertical direction at said one of the upper surface of and lower surface of said plug portion.

6. A receptacle connector, comprising:
a receptacle housing comprising a plug accommodation portion having formed therein a plug accommodation space comprising a concave portion having an inner wall and open at a front surface side and being for accommodating in said plug accommodation space a flat plug portion which extends in a left-right direction in a matable plug connector; and
a receptacle-side signal contact provided at an upper surface of the inner wall of said plug accommodation space in said plug accommodation portion and connected to a signal line, the receptacle connector being configured such that said receptacle-side signal contact is brought into contact with a plug-side signal contact of said plug connector when said plug portion has been inserted into said plug accommodation space and said receptacle housing has been mated with said plug housing, wherein
a receptacle-side power source contact for connection to a power source line is provided at a lower surface of the inner wall of said plug accommodation space in said plug accommodation portion.

7. The receptacle connector according to claim 6 wherein the plug accommodation portion has an outer periphery surrounding said plug accommodation space and covered with a shielding member composed of an electrically conductive material.

8. The receptacle connector according to claim 6 wherein said plug accommodation space is formed as a concave portion having a left side surface and a right side surface and an L-shaped cross section extending in a front-back direction, so that one of the left side surface and right side surface has a greater vertical height than another of the left side surface and the right side surface and a grounded receptacle-side ground contact is provided at the side surface with the greater vertical height.

9. The receptacle connector according to claim 6, wherein any one of said receptacle-side signal contact and said receptacle-side power source contact is mounted immovably at the inner wall of said plug accommodation space and another of said receptacle-side signal contact and said receptacle-side power source contact is mounted for elastic deformation in a vertical direction provided at the inner wall of said plug accommodation space.

10. A connector assembly composed of mutually joinable plug connector according to any of claims 1 to 5 and receptacle connector according to any of claims 6 to 9.

11. The connector assembly according to claim 10, wherein said receptacle-side power source contact is formed to have a flat shape and is
